(19) United States
(12) Patent Application Publication
(10) Pub. No.: US 2024/0372671 A1
(43) Pub. Date: Nov. 7, 2024

(54) SOUNDING REFERENCE SIGNAL BASED SPECTRUM SENSING ACROSS MULTIPLE UPLINK POSITIONING SESSIONS

(71) Applicant: Nokia Technologies Oy, Espoo (FI)

(72) Inventors: Diomidis MICHALOPOULOS, Munich (DE); Oana-Elena BARBU, Aalborg (DK); Daejung YOON, Nozay (FR)

(21) Appl. No.: 18/688,884

(22) PCT Filed: Jul. 8, 2022
(86) PCT No.: PCT/FI2022/050493

§ 371 Date: Mar. 4, 2024

Related U.S. Application Data
(60) Provisional application No. 63/242,770, filed on Sep. 10, 2021.

(51) Int. Cl. H04L 5/00; H04B 17/336

(52) U.S. Cl. CPC H04L 5/0051; H04B 17/336

(57) ABSTRACT

Systems, methods, apparatuses, and computer program products for improved uplink (UL) positioning are provided. One method may include transmitting, by a location management entity, a request for spectrum sensing information to one or more serving network nodes and neighbor network nodes (650), receiving the spectrum sensing information from the one or more serving network nodes and neighboring network nodes (655), calculating sounding reference signal (SRS) resources for the one or more serving network nodes using the received spectrum sensing information (665), indicating, to the one or more serving network nodes, a list of sounding reference signal (SRS) configurations obtained based on the calculated sounding reference signal (SRS) resources (670), and receiving, from the one or more serving network nodes, an indication of a selected one of the sounding reference signal (SRS) configurations (675).

### CROSS-REFERENCE TO RELATED APPLICATIONS

This application claims priority from U.S. provisional patent application No. 63/242,770 filed on Sep. 10, 2021. The entire contents of this earlier filed application are hereby incorporated by reference in their entirety.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for uplink (UL) positioning.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to a method that may include transmitting a request for spectrum sensing information to a serving network node and one or more neighbor network nodes associated with multiple positioning sessions of multiple target devices, receiving the spectrum sensing information from the serving network node and the one or more neighboring network nodes, calculating, using the received spectrum sensing information, sounding reference signal (SRS) resources to be utilized by at least one of the multiple target devices, indicating, to the serving network node associated with the multiple positioning sessions, a list of sounding reference signal (SRS) configurations obtained based on the calculated sounding reference signal (SRS) resources, and receiving, from the serving network node, an indication of a selected at least one of the sounding reference signal (SRS) configurations.

An embodiment may be directed to an apparatus that may include at least one processor and at least one memory comprising computer program code. The at least one memory and computer program code are configured, with the at least one processor, to cause the apparatus at least to perform: transmitting a request for spectrum sensing information to a serving network node and one or more neighbor network nodes associated with multiple positioning sessions of multiple target devices, receiving the spectrum sensing information from the serving network node and the one or more neighboring network nodes, calculating, using the received spectrum sensing information, sounding reference signal (SRS) resources to be utilized by at least one of the multiple target devices, indicating, to the serving network node associated with at least one of the multiple positioning sessions, a list of sounding reference signal (SRS) configurations obtained based on the calculated sounding reference signal (SRS) resources, and receiving, from the serving network node, an indication of a selected at least one of the sounding reference signal (SRS) configurations.

An embodiment may be directed to an apparatus that may include means for: transmitting a request for spectrum sensing information to a serving network node and one or more neighbor network nodes associated with multiple positioning sessions of multiple target devices, receiving the spectrum sensing information from the serving network node and the one or more neighboring network nodes, calculating, using the received spectrum sensing information, sounding reference signal (SRS) resources to be utilized by at least one of the multiple target devices, indicating, to the serving network node associated with at least one of the multiple positioning sessions, a list of sounding reference signal (SRS) configurations obtained based on the calculated sounding reference signal (SRS) resources, and receiving, from the serving network node, an indication of a selected at least one of the sounding reference signal (SRS) configurations.

An embodiment may be directed to a method that may include receiving, by a network node, a request for spectrum sensing from a location management entity, performing the spectrum sensing, and transmitting an outcome of the spectrum sensing to the location management entity. In some embodiments, the method may also include receiving, from the location management entity, a list of sounding reference signal (SRS) configurations, evaluating the list of sounding reference signal (SRS) configurations and selecting at least one of the sounding reference signal (SRS) configurations, and transmitting, to the location management entity, an indication of the selected at least one of the sounding reference signal (SRS) configurations.

An embodiment may be directed to an apparatus that may include at least one processor and at least one memory comprising computer program code. The at least one memory and computer program code are configured, with the at least one processor, to cause the apparatus at least to perform: receiving a request for spectrum sensing from a location management entity, performing the spectrum sensing, and transmitting an outcome of the spectrum sensing to the location management entity. In some embodiments, the at least one memory and computer program code are configured, with the at least one processor, to cause the apparatus at least to perform: receiving, from the location management entity, a list of sounding reference signal (SRS) configurations, evaluating the list of sounding reference signal (SRS) configurations and selecting at least one of the sounding reference signal (SRS) configurations, and transmitting, to the location management entity, an indication of the selected at least one of the sounding reference signal (SRS) configurations.

An embodiment may be directed to an apparatus that may include means for: receiving a request for spectrum sensing from a location management entity, performing the spectrum sensing, and transmitting an outcome of the spectrum sensing to the location management entity. In some embodiments, the apparatus may further include means for: receiving, from the location management entity, a list of sounding reference signal (SRS) configurations, evaluating the list of sounding reference signal (SRS) configurations and selecting at least one of the sounding reference signal (SRS) configurations, and transmitting, to the location management entity, an indication of the selected at least one of the sounding reference signal (SRS) configurations.

### BRIEF DESCRIPTION OF THE DRAWINGS

For proper understanding of example embodiments, reference should be made to the accompanying drawings, wherein:

FIG. 1 illustrates an example signaling diagram depicting the UL time difference of arrival (TDoA) procedure, according to an embodiment;

FIG. 2 illustrates an example of a frequency-reuse deployment scenario;

FIG. 3 illustrates an example of a compromised positioning session;

FIG. 4 illustrates an example signaling diagram for a method, according to one embodiment;

FIG. 5 illustrates an example of SRS configuration switching concept for positioning, according to an embodiment;

FIG. 6A illustrates an example flow diagram of a method, according to an embodiment;

FIG. 6B illustrates an example flow diagram of a method, according to an embodiment;

FIG. 7A illustrates an example block diagram of an apparatus, according to an embodiment;

FIG. 7B illustrates an example block diagram of an apparatus, according to an embodiment; and

FIG. 7C illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for UL positioning, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Certain embodiments described herein may generally relate to UL and/or DL positioning methods. More specifically, some embodiments may relate to methods, measurements, signaling, and/or procedures for improving positioning accuracy, e.g., by mitigating UE receiver (Rx)/transmitter (Tx) and/or gNB Rx/TX timing delays including UL, DL and DL+UL methods, as well as UE-based and UE-assisted positioning solutions. Furthermore, some embodiments may also relate to procedures, measurements, reporting and/or signaling for improving the accuracy of UL angle of arrival (AoA) for network-based positioning solution or of DL angle of departure (AoD) for UE-based and network based (including UE-assisted) positioning solution.

Thus, some example embodiments may be configured to reduce interference in UL positioning, thereby improving the accuracy of both time-based UL positioning (UL-TDoA) and angle-based UL positioning (UL-AoA).

One problem that can be addressed by certain embodiments described herein includes the potential interference of UL positioning reference signals, which may be referred to as sounding reference signals (SRS) or positioning sounding reference signals (pSRS), transmitted by different target UE devices and arriving at the same network measuring node (i.e., gNB or transmission/reception point-TRP).

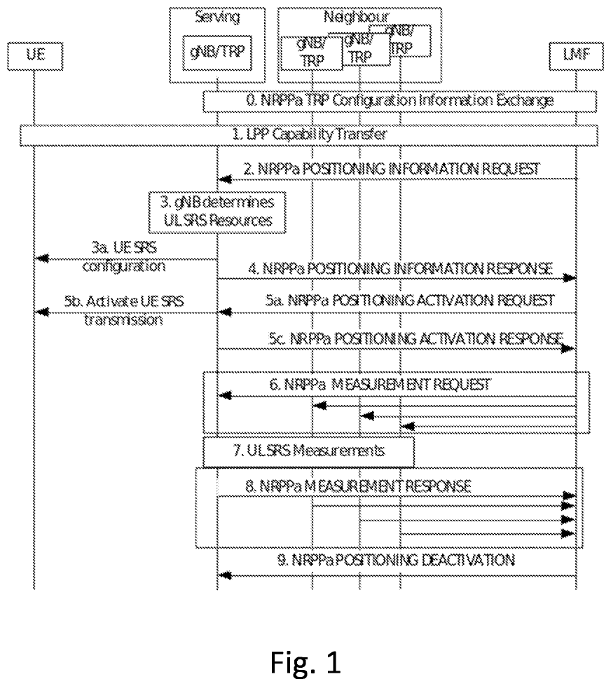

More specifically, in UL positioning, the target UE may be configured by its serving gNB to transmit pSRS. The configuration may follow after a request arrives at serving gNB from the location management function (LMF), where, in this request, the LMF indicates the necessary UL resources as this is determined by the quality of service (QoS) of the positioning session that the LMF is handling. FIG. 1 illustrates an example signaling diagram depicting the UL time difference of arrival (TDoA) procedure, according to an embodiment.

As illustrated in the example of FIG. 1, at 0, the LMF may perform NR positioning protocol A (NRPPa) transmission-reception point (TRP) configuration information exchange with the serving and neighbour gNB(s)/TRP(s). It is noted that, in certain embodiments described herein, gNB and TRP may be used interchangeably. At 1, LTE positioning protocol (LPP) capability transfer may be performed. The LMF may, at 2, transmit a NRPPa position information request to the serving gNB/TRP. At 3, the serving gNB/TRP may determine UL SRS resources and, at 3a, configure the UE to transmit SRS. The serving gNB/TRP may then, at 4, transmit a NRPPa positioning information response to the LMF. At 5a, the serving gNB/TRP may receive, from the LMF, a NRPPa positioning activation request, and may, at 5b, activate UE SRS transmission. At 5c, the serving gNB/TRP may transmit a NRPPa positioning activation response to the LMF. At 6, the LMF may transmit NRPPa measurement request(s) to the serving and neighbour gNB(s)/TRP(s). The gNBs/TRPs may, at 7, perform UL SRS measurements and, at 8, provide NRPPa measurement response(s) to the LMF. At 9, the LMF may transmit NRPPa positioning deactivation.

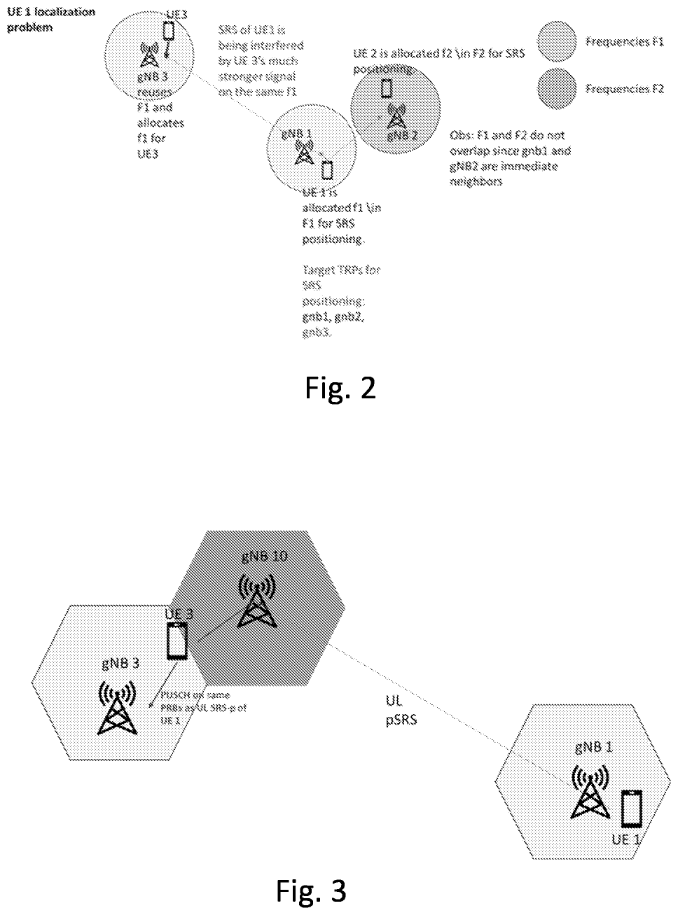

However, a problem with the existing protocol is that, as can be seen from FIG. 1, there is no coordination between neighbouring gNBs as to what SRS resources a serving gNB should configure to a target UE, such that these specific SRS resources do not cause (or at least minimize) interference with other target UEs whose SRS are also measured by the same neighbour gNB. To better illustrate the aforementioned problem, consider the typical frequency-reuse deployment scenario where adjacent cells (gNBs) are allocated non-overlapping frequencies while gNBs that are far apart may use the same frequency. This is depicted in the example of FIG. 2. In this scenario, although SRS configured by adjacent gNBs do not cause interference since those gNBs operate in non-overlapping frequencies, this is not the case for far apart gNBs. With reference to the example of FIG. 2, UE1 and UE2 are configured with non-overlapping SRS, however UE1 and UE3 are likely to be configured with overlapping SRS resources since their cells are far apart and, hence, they potentially reuse the same frequency.

It is noted that in positioning the set of neighbouring cells measuring the SRS transmitted by a target UE is relatively large, i.e., much larger than the set of nearby cells that are potential candidates for handover for mobility purposes. In other words, SRS are heard and measured by a substantially large set of neighbouring cells, which is a condition for positioning to yield sufficiently high accuracy. Typically, the number of neighbouring cells measuring SRS can include up to 64 neighbouring cells. As a result, given that each SRS can be measured by up to 64 gNBs, the likelihood that there exists at least one gNB that serves as a neighbouring cell to at least two concurrent UL positioning sessions with SRS at the same frequency, is relatively high. This phenomenon becomes more evident the larger the number of concurrent target UEs (e.g., in a massive IoT scenario), and the more dense the deployment of gNBs (which is a common case in NR).

It should be noted that the above problem can be generalized to other cases, such as the following. First, in the example of FIG. 2, when UE3 transmits an UL signal on resources allocated for UL positioning of UE1, then the localization of UE1 may be compromised by the interference caused by UE3. Second, even if gNB3 rejects the LMF request to measure UE1 because it is aware that the measurement will be interfered, the same cannot be said for any of the neighboring gNBs of gNB 3.

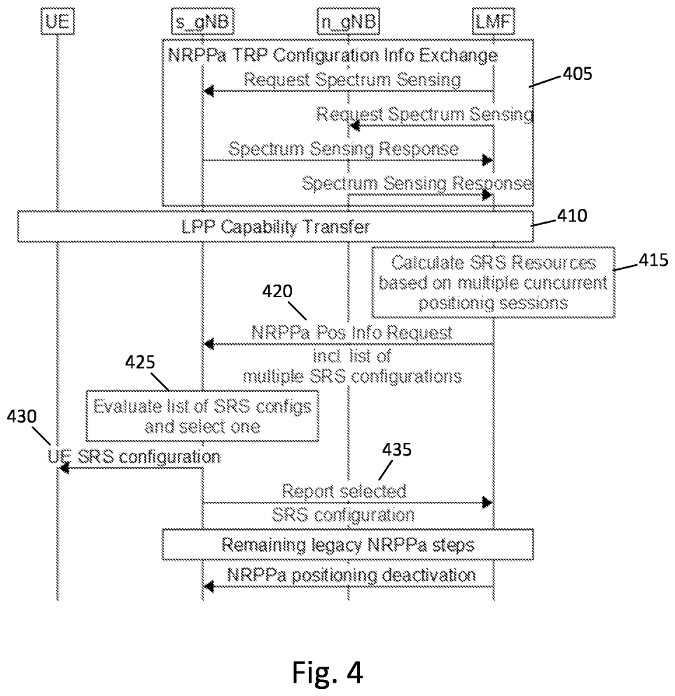

FIG. 3 illustrates an example of a compromised positioning session. In the example of FIG. 3, UL pSRS of UE 1 and physical uplink shared channel (PUSCH) of UE3 use the same physical resource blocks (PRBs). In this example, gNB 10 is requested to measure UL pSRS of UE 1. UE3, served by gNB3, is at cell edge and interferes UL pSRS reception at gNB 10. Also, gNB 10 does not know in advance that UE3 uses the same PRBs as UE1 and has no preliminary reason to reject a measurement request coming from the LMF. Hence, gNB 10 measures UL pSRS of UE1, even though they are severely interfered with and reports an unreliable measurement.

As can be seen from the above, it would be desirable to have a proper mechanism in place for coordinating the SRS configuration across multiple target UEs served by distinct gNBs on one hand, yet not too far so as their SRS are measured by common neighbour gNBs. Certain example embodiments provided herein are configured at least to cover this gap in interfering SRS in dense deployments, for example, by utilizing spectrum sensing at the targeted neighbouring gNBs, and signalling such information to a central network entity (e.g., the LMF).

According to some example embodiments, gNB(s), such as the serving and neighboring gNBs, involved in an UL positioning session may perform spectrum sensing and provide the outcome of their sensing to the LMF. Then, in an embodiment, the LMF can process the information received from the gNBs (i.e., the serving gNB and all neighbor gNBs) of a given positioning session, together with spectrum sensing information it obtains from other gNBs performing concurrent UL traffic, i.e., UL positioning or UL data transfer.

In certain embodiments, the LMF may run a local implementation method to obtain an optimized coordination of the SRS resource allocation of concurrent positioning sessions, such that the cross-SRS interference is minimized. Then, in an embodiment, the LMF may communicate, to the serving gNB of the UE associated to the positioning sessions, the outcome of the SRS configuration process, so that the serving gNB can configure SRS resources to the UE accordingly.

For example, in certain embodiments, the LMF can include a new information element (IE) in the NRPPa configuration information exchange message, e.g., as depicted in the example of FIG. 1, to both serving and neighboring gNBs, requesting spectrum sensing information (SSI). According to some embodiments, the SSI may include a metric characterizing the utilization of the indicated spectrum, such as signal-to-noise ratio (SNR), signal-to-noise and interference ratio (SINR), reference signal received power (RSRP), etc., per subcarrier, per bandwidth, per bandwidth part, etc. In an embodiment, the SSI may be measured and/or predicted using any available spectrum sensing methods.

According to certain embodiments, the serving and neighbouring gNBs may respond with a new NRPPa IE conveying the outcome of the spectrum sensing. For example, each of the responders may return a list of bandwidth part (BWP) ordered by their utilization, e.g., BWP X-90% utilization, etc. In an embodiment, the LMF may then combine the received spectrum sensing information from multiple concurrent positioning sessions, and can proactively provide to serving gNB(s) multiple sets of SRS configurations.

More specifically, in an embodiment, the LMF can optimally decide on a list of SRS configurations per session, accounting for the positioning QoS of the target UE and before checking whether the SRS configuration is accepted by the gNB. Then, the LMF may communicate the list of SRS configurations to the corresponding serving gNB(s) of each of the multiple positioning sessions. According to an embodiment, the serving gNB(s) may evaluate the list, and select and report back a preferred SRS configuration.

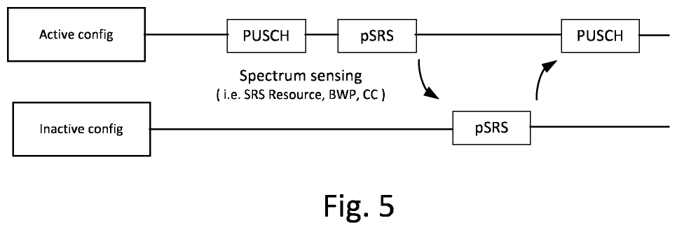

FIG. 4 illustrates an example signaling diagram for a method, according to one embodiment. As illustrated in the example of FIG. 4, at 405, the request(s) for spectrum sensing to serving and neighbor gNB(s) and subsequent response(s) can take place during the NRPPa TRP configuration information exchange process, e.g., at the start of the NRPPa process as shown in FIG. 1. For example, the request for spectrum sensing may contain a list of carrier frequencies, component carriers and/or bandwidth parts for which the TRPs are requested to report spectrum utilization: {fc1, fc2, . . . }, (fc1: BWP1, BWP2), etc. In an embodiment, the LMF may also indicate which spectrum utilization metrics are to be measured, e.g. SNR, SINR, received signal strength indicator (RSSI), etc. According to some embodiments, the LMF may also request a spectrum utilization report per TRP beam, which means that the TRP needs to report the above metrics for each of its receive beams. The LMF, at 410, may initiate the LPP capability transfer procedure with the UE upon collection of the relevant spectrum sensing information.

According to certain embodiments, the LMF may combine the spectrum sensing information from the positioning process of interest with other concurrent positioning processes involving the same gNBs/TRPs. For example, the spectrum sensing information may refer to spectrum occupancy, traffic types per PRB, bandwidth and/or bandwidth part, etc. Based on the collected information, at 415, the LMF can calculate the SRS resources for each relevant serving gNB. In one embodiment, the LMF may obtain multiple SRS configuration sets per serving gNB, in form of a list with SRS configurations in order of preference. Also, in some embodiments, the LMF may include a switching method to set SRS configuration set(s) indicated from layer 1 (L1) or higher layer signaling.

As illustrated in the example of FIG. 4, at 420, the LMF may indicate to the serving gNB the list of SRS configurations in order of preference, e.g., as part of a NRPPa positioning information request message. At 425, the serving gNB may evaluate the obtained list of SRS configurations and select one of the SRS configurations. In another embodiment, the serving gNB may select multiple SRS configurations as fallback option, and may indicate the conditions under which SRS configurations are switched from one to the other. At 430, the serving gNB may configure SRS to the UE. At 435, the serving gNB may indicate the selection of the one or more SRS configurations to the LMF. The remaining NRPPa procedures may then be completed.

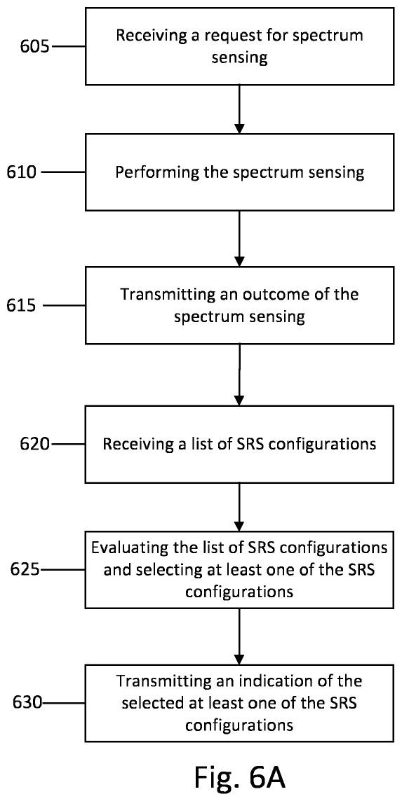

As regards the spectrum sensing operation for positioning, example embodiments provide several options as discussed below and depicted in the example of FIG. 5. In particular, FIG. 5 illustrates an example of SRS configuration switching concept for positioning, according to an embodiment. In this example, configuration setting can include SRS resource, BWP and/or component carrier (CC). A network device or gNB that receives a spectrum sensing request can conduct spectrum sensing according to several options.

In one option, average noise level occupied over the channel bandwidth of an indicated spectrum may be measured without any UL transmission scheduling.

In a second option, a received power and a noise power on SRS transmitted from co-scheduled UEs may be measured. For example, for this option, Release-15 SRS carrier switching concept can be used. Release-15 SRS carrier switching supports instantaneous measurement of UL link coverage (i.e., UL-RSRP) toward a serving cell. In some embodiments, the LMF may trigger a SRS carrier switching operation between a neighbor cell and a target UE through LMF coordination. The network device or gNB may measure SNR using carrier switching SRS over noise in the indicated spectrum. It is noted that, in certain embodiments, co-scheduled UEs may refer to a set of UEs that share the same scheduled resources, where those resources may include PRB across time and frequency, PRB set, bandwidth, bandwidth part, carrier, and/or group of carriers, etc.

In a third option, a received power and a noise and interference power may be measured on SRS transmitted from the co-scheduled UEs. According to some embodiments, the LMF may trigger SRS carrier switching operation between a neighbor cell and a target UE through LMF coordination. The LMF can also trigger SRS transmissions with interference hypothesis from interfering UE candidates. The LMF can test interference scenarios among specific UE groups. The network device or gNB may measure SINR using carrier switching SRS over interference power of co-scheduled interfering UEs as well as noise in the indicated spectrum.

It is noted that the various options outlined above can be applicable to CC or BWP when initially requesting SRS configuration from LMF to a cell as well.

In order to support the spectrum sensing, a gNB may be configured to trigger SRS transmission in another spectrum and switch UL carrier or UL configuration corresponding to the switched spectrum. In Release-15, there was a part of the carrier aggregation (CA) feature to measure UL coverage and UL-RSRP in another component carriers (CC) through SRS carrier switching. While the Release-15 feature is to measure CCs of PSCells only of the serving cell, certain example embodiments may be configured to trigger the SRS configuration switching including SRS resource allocation, BWP or CC associated with multiple cells for positioning purpose as illustrated in the example of FIG. 5. The scheme includes a fallback mode switching or preference order-based switching as well as L1 and higher layer signaling based switching, such as SRS carrier switching or BWP.

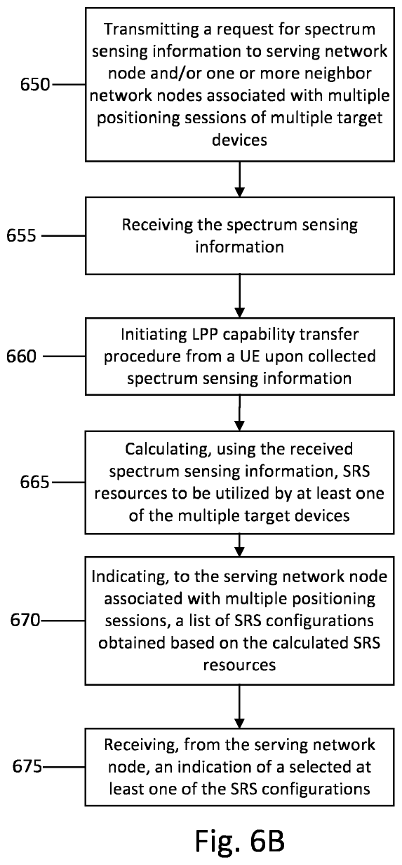

FIG. 6A illustrates an example flow diagram of a method for UL positioning, according to one embodiment. In certain example embodiments, the flow diagram of FIG. 6A may be performed by a network entity or network node in a communications system, such as LTE or 5G NR. In some example embodiments, the network entity performing the method of FIG. 6A may include or be included in a base station, access node, node B, eNB, gNB, NG-RAN node, TRPs, high altitude platform stations (HAPS), relay station or the like. For example, according to certain embodiments, the entity performing the method of FIG. 6A may include a serving gNB or TRP or neighboring gNB or TRP, such as those illustrated in the examples of FIGS. 1-4, or any other entity discussed herein.

As illustrated in the example of FIG. 6A, the method may include, at 605, receiving a request for spectrum sensing from a location management entity, such as a LMF. In an embodiment, the request for spectrum sensing information may include at least one of a list of carrier frequencies, component carriers, frequency range or bandwidth parts for which spectrum utilization should be reported. In a further embodiment, the request for spectrum sensing information may include an indication of which spectrum utilization metrics are to be measured, such as SNR, SINR, RSRP, RSRQ, RSSI, etc. In another embodiment, the request for spectrum sensing may include a request for directional reported information, such as a spectrum utilization report per TRP beam, e.g., such that the requested metrics are reported for each receive beam.

In an embodiment, the method may include, at 610, performing the spectrum sensing in accordance with the received request. According to one embodiment, the performing 610 of the spectrum sensing may include measuring average noise level occupied over a channel bandwidth of an indicated spectrum without any uplink (UL) transmission scheduling.

In a further embodiment, the performing 610 of the spectrum sensing may include measuring a received power and a noise power on SRS transmitted from co-scheduled UEs. For example, in this case, Release-15 SRS carrier switching can be used and/or the location management entity may trigger SRS carrier switching between a neighbor cell and target UE. Thus, in an embodiment, the measuring may include measuring SNR using carrier switching SRS over noise in the indicated spectrum. As discussed above, in certain embodiments, co-scheduled UEs may refer to a set of UEs that share the same resources, where those resources may be PRB across time and frequency, PRB set, bandwidth, bandwidth part, carrier, and/or group of carriers, etc.

In yet a further embodiment, the performing 610 of the spectrum sensing may include measuring a received power and a noise and interference power on SRS transmitted from the co-scheduled UEs. For example, the location management entity may trigger SRS carrier switching operation between a neighbor cell and target UE, and/or the location management entity may trigger SRS transmission with interference hypothesis from interfering UE candidates. Thus, in an embodiment, the measuring may include measuring SINR using carrier switching SRS over interference power of co-scheduled interfering UEs as well as noise in the indicated spectrum.

In some embodiments, the method may include triggering the SRS configuration switching including SRS resource allocation, BWP or CC associated with multiple cells for positioning purposes. This may include fallback mode switching or preference order-based switching, as well as L1 and higher layer signaling based switching.

As further illustrated in the example of FIG. 6A, the method may include, at 615, transmitting an outcome of the spectrum sensing to the location management entity. For example, the transmitting 615 may include transmitting the outcome of the spectrum sensing in an information element in a NRPPa configuration information exchange message.

In an embodiment, the method may include, at 620, receiving, from the location management entity, a list of SRS configurations. For example, the list of SRS configurations may include the SRS configurations in order of preference. The method may then include, at 625, evaluating the list of SRS configurations and selecting at least one of the SRS configurations. In some embodiments, the selecting may include selecting multiple SRS configurations as fallback options and deciding conditions under which the SRS configurations may be switched from one configuration to another. According to an embodiment, the method may include, at 630, transmitting, to the location management entity, an indication of the selected at least one of the SRS configurations, and optionally indicated the conditions under which the SRS configurations are switched from one to another, if applicable. In one embodiment, the method may further include configuring SRS associated with at least one of the selected SRS configurations to at least one UE.

FIG. 6B illustrates an example flow diagram of a method for UL positioning, according to one embodiment. In certain example embodiments, the flow diagram of FIG. 6B may be performed by a network entity or network node in a communications system, such as LTE or 5G NR. In some example embodiments, the network entity performing the method of FIG. 6B may include or be included in a base station, access node, node B, eNB, gNB, NG-RAN node, transmission-reception points (TRPs), high altitude platform stations (HAPS), relay station or the like. For example, according to certain embodiments, the entity performing the method of FIG. 6B may include a location management entity or LMF, such as those illustrated in the examples of FIGS. 1-4, or any other entity discussed herein.

As illustrated in the example of FIG. 6B, the method may include, at 650, transmitting a request for spectrum sensing information to a serving network node and/or one or more neighbor network nodes, such as serving or neighboring gNB(s) or TRP(s), associated with multiple positioning sessions of multiple target devices. In an embodiment, the transmitting 650 may include transmitting the request for spectrum sensing information in an information element in a NRPPa configuration information exchange message. According to an embodiment, the request for spectrum sensing information may include at least one of a list of carrier frequencies, component carriers, frequency range, or bandwidth parts for which the network nodes should report spectrum utilization. In a further embodiment, the request for spectrum sensing information comprises an indication of which spectrum utilization metrics, such as SNR, SINR, RSRP, RSRQ, RSSI, etc. are to be measured. In yet a further embodiment, the request for spectrum sensing information may include a request for a spectrum utilization report per TRP beam, e.g., such that the network node reports its spectrum utilization metrics for each of its receive beams.

As further illustrated in the example of FIG. 6B, the method may include, at 655, receiving the spectrum sensing information from the one or more serving and/or neighboring network nodes. In an embodiment, the method may then include, at 660, initiating LPP capability transfer procedure from a UE. According to certain embodiments, the method may include, at 665, calculating SRS resources to be utilized by one or more of the target devices using the received spectrum sensing information. In an embodiment, the calculating 665 is configured to result in set of SRS configurations per positioning session, accounting for the positioning QoS of the target UE and prior to checking whether the SRS configuration is accepted by the serving network node. In an embodiment, the calculating 665 may include combining the spectrum sensing information from a positioning process of interest with other concurrent positioning processes involving the same serving or neighboring network nodes. In a further embodiment, the calculating 665 may include obtaining multiple SRS configuration sets per network node. In yet a further embodiment, the calculating 665 may include providing or applying a switching method to switch between SRS configuration sets, e.g., as indicated from layer 1 or higher layer signaling.

According to some embodiments, the method may further include, at 670, indicating, to the serving network node associated with one or more of the multiple positioning sessions, a list of SRS configurations obtained based on the calculated SRS resources. In one embodiment, the list of SRS configurations may include the SRS configurations in order of preference of the location management entity or LMF. The method may further include, at 675, receiving, from the serving network node, an indication of a selected at least one of the SRS configurations. In some embodiments, the serving network node may select multiple SRS configurations as fallback options and, in such case, the receiving 675 may include receiving an indication of the conditions under which SRS configurations can be switched from one to another.

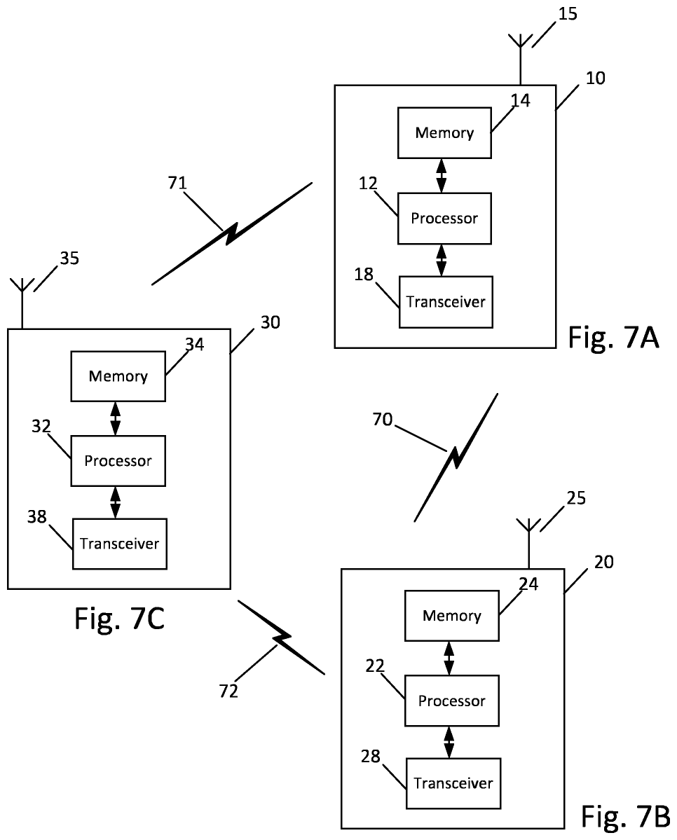

FIG. 7A illustrates an example of an apparatus 10 according to an embodiment. In an embodiment, apparatus 10 may be a node, host, or server in a communications network or serving such a network. For example, apparatus 10 may be a satellite, base station, a Node B, an evolved Node B (eNB), 5G Node B or access point, next generation Node B (NG-NB or gNB), transmission receive point (TRP), high altitude platform station (HAPS), integrated access and backhaul (IAB) node, and/or WLAN access point, associated with a radio access network, such as a LTE network, 5G or NR. In one example embodiment, apparatus 10 may represent serving gNB or TRP or a neighboring gNB or TRP, such as those illustrated in FIGS. 1-4.

It should be understood that, in some example embodiments, apparatus 10 may be comprised of an edge cloud server as a distributed computing system where the server and the radio node may be stand-alone apparatuses communicating with each other via a radio path or via a wired connection, or where they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 7A.

As illustrated in the example of FIG. 7A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples.

While a single processor 12 is shown in FIG. 7A, multiple processors may be utilized according to other example embodiments. For example, it should be understood that, in certain embodiments, apparatus 10 may include two or more processors that may form a multiprocessor system (e.g., in this case processor 12 may represent a multiprocessor) that may support multiprocessing. In some embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and/or receive information. The transceiver 18 may include, for example, a plurality of radio interfaces that may be coupled to the antenna(s) 15, or may include any other appropriate transmitting or receiving means. In certain embodiments, the radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and/or the like. According to an example embodiment, the radio interface may include components, such as filters, converters (e.g., digital-to-analog converters and the like), mappers, a Fast Fourier Transform (FFT) module, and/or the like, e.g., to generate symbols or signals for transmission via one or more downlinks and to receive symbols (e.g., via an uplink).

As such, transceiver 18 may be configured to modulate information on to a carrier waveform for transmission by the antenna(s) 15 and to demodulate information received via the antenna(s) 15 for further processing by other elements of apparatus 10. In other example embodiments, transceiver 18 may be capable of transmitting and receiving signals or data directly. Additionally or alternatively, in some embodiments, apparatus 10 may include an input device and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiver circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a network node or RAN node, such as a base station, access point, Node B, eNB, gNB, TRP, HAPS, IAB node, WLAN access point, or the like. In one example embodiment, apparatus 10 may be a NF, AF, SMF, or other 5GC node. For example, in some embodiments, apparatus 10 may be configured to perform one or more of the processes depicted in any of the flow charts or signaling diagrams described herein, such as those illustrated in any of FIGS. 1-6. In some embodiments, as discussed herein, apparatus 10 may be configured to perform a procedure relating to UL positioning, for example.

FIG. 7B illustrates an example of an apparatus 20 according to another embodiment. In an embodiment, apparatus 20 may be a node or element in a communications network or associated with such a network, such as a satellite, base station, a Node B, an evolved Node B (eNB), 5G Node B or access point, next generation Node B (NG-NB or gNB), transmission receive point (TRP), high altitude platform station (HAPS), integrated access and backhaul (IAB) node, and/or WLAN access point, associated with a radio access network, such as a LTE network, 5G or NR. In one example embodiment, apparatus 20 may represent a location management entity, such as the LMF illustrated in FIGS. 1-4.

It should be understood that, in some example embodiments, apparatus 20 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 20 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 20 may include components or features not shown in FIG. 7B.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 7B.

As illustrated in the example of FIG. 7B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 7B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 or apparatus 30 via a wireless or wired communications link or interface 70 according to any radio access technology, such as NR.

According to some embodiments, processor 22 and memory 24 may be included in or may form a part of processing circuitry/means or control circuitry/means. In addition, in some embodiments, transceiver 28 may be included in or may form a part of transceiving circuitry or transceiving means.

As discussed above, according to some embodiments, apparatus 20 may be a location management entity, such as a LMF, for example. According to certain embodiments, apparatus 20 may be controlled by memory 24 and processor 22 to perform the functions associated with example embodiments described herein. For example, in some embodiments, apparatus 20 may be configured to perform one or more of the processes depicted in any of the flow charts or signaling diagrams described herein, such as those illustrated in FIGS. 1-6. Thus, according to an embodiment, apparatus 20 may be configured to perform a procedure relating to UL positioning, as discussed elsewhere herein, for instance.

FIG. 7C illustrates an example of an apparatus 30 according to another example embodiment. In an example embodiment, apparatus 30 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 30 may be implemented in, for instance, a wireless handheld device, a wireless plug-in accessory, or the like. It should be noted that one of ordinary skill in the art would understand that apparatus 30 may include components or features not shown in FIG. 7C.

In some example embodiments, apparatus 30 may include one or more processors, one or more computer-readable storage medium (for example, memory, storage, or the like), one or more radio access components (for example, a modem, a transceiver, or the like), and/or a user interface. In some example embodiments, apparatus 30 may be configured to operate using one or more radio access technologies, such as GSM, LTE, LTE-A, NR, 5G, WLAN, WiFi, NB-IoT, MulteFire, and/or any other radio access technologies. It should be noted that one of ordinary skill in the art would understand that apparatus 30 may include components or features not shown in FIG. 7C.

As illustrated in the example of FIG. 7C, apparatus 30 may include or be coupled to a processor 32 for processing information and executing instructions or operations. Processor 32 may be any type of general or specific purpose processor. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 32 is shown in FIG. 7C, multiple processors may be utilized according to other example embodiments. For example, it should be understood that, in certain example embodiments, apparatus 30 may include two or more processors that may form a multiprocessor system (e.g., in this case processor 32 may represent a multiprocessor) that may support multiprocessing. In certain example embodiments, the multiprocessor system may be tightly coupled or loosely coupled (e.g., to form a computer cluster).

Processor 32 may perform functions associated with the operation of apparatus 30 including, as some examples, precoding of antenna gain/phase parameters, encoding and decoding of individual bits forming a communication message, formatting of information, and overall control of the apparatus 30, including processes related to management of communication resources.

Apparatus 30 may further include or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 34 can be comprised of any combination of random access memory (RAM), read only memory (ROM), static storage such as a magnetic or optical disk, hard disk drive (HDD), or any other type of non-transitory machine or computer readable media. The instructions stored in memory 34 may include program instructions or computer program code that, when executed by processor 32, enable the apparatus 30 to perform tasks as described herein.

In an example embodiment, apparatus 30 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 32 and/or apparatus 30.

In some example embodiments, apparatus 30 may also include or be coupled to one or more antennas 35 for receiving a downlink signal and for transmitting via an uplink from apparatus 30. Apparatus 30 may further include a transceiver 38 configured to transmit and receive information. The transceiver 38 may also include a radio interface (e.g., a modem) coupled to the antenna 35. The radio interface may correspond to a plurality of radio access technologies including one or more of GSM, LTE, LTE-A, 5G, NR, WLAN, NB-IoT, BT-LE, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 38 may be configured to modulate information on to a carrier waveform for transmission by the antenna(s) 35 and demodulate information received via the antenna(s) 35 for further processing by other elements of apparatus 30. In other example embodiments, transceiver 38 may be capable of transmitting and receiving signals or data directly. Additionally or alternatively, in some example embodiments, apparatus 30 may include an input and/or output device (I/O device). In certain example embodiments, apparatus 30 may further include a user interface, such as a graphical user interface or touchscreen.

In an example embodiment, memory 34 stores software modules that provide functionality when executed by processor 32. The modules may include, for example, an operating system that provides operating system functionality for apparatus 30. The memory may also store one or more functional modules, such as an application or program, to provide additional functionality for apparatus 30. The components of apparatus 30 may be implemented in hardware, or as any suitable combination of hardware and software. According to an example embodiment, apparatus 30 may optionally be configured to communicate with apparatus 10 via a wireless or wired communications link 71 and/or to communicate with apparatus 20 via a wireless or wired communications link 72, according to any radio access technology, such as NR.

According to some example embodiments, processor 32 and memory 34 may be included in or may form a part of processing circuitry or control circuitry. In addition, in some example embodiments, transceiver 38 may be included in or may form a part of transceiving circuitry.

As discussed above, according to some example embodiments, apparatus 30 may be a UE, communication node, mobile equipment (ME), mobile station, mobile device, stationary device, IoT device, for example. According to certain example embodiments, apparatus 30 may be controlled by memory 34 and processor 32 to perform the functions associated with example embodiments described herein. For instance, in some example embodiments, apparatus 30 may be configured to perform one or more of the processes depicted in any of the diagrams or signaling flow diagrams described herein, such as those illustrated in FIGS. 1-6. According to certain example embodiments, apparatus 30 may be configured to perform a procedure relating to UL positioning, for instance.

In some embodiments, an apparatus (e.g., apparatus 10, apparatus 20, and/or apparatus 30) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. For example, as discussed in detail above, certain embodiments are configured to coordinate between multiple SRS transmissions and minimizes potential interference from multiple UEs transmitting SRS to common neighbor gNBs/TRPs. Some embodiments provide mechanisms to determine SRS configuration set(s) with the best positioning measurement condition in terms of positioning QoS in serving and neighbor gNBs/TRPs. Therefore, an embodiment can contribute towards higher accuracy UL positioning. Further, example embodiments minimize the probability that one or more TRPs will reject a measurement request from the LMF for an already configured positioning session. This, in turn, contributes to further reducing the latency of the positioning session. Accordingly, the use of certain example embodiments results in improved functioning of communications networks and their nodes, such as base stations, eNBs, gNBs, and/or IoT devices, UEs or mobile stations.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1-61. (canceled)

62. An apparatus, comprising:
at least one processor; and
at least one memory comprising computer program code,
the at least one memory and computer program code configured, with the at least one processor, to cause the apparatus at least to:
transmit, respectively, a request for spectrum sensing information to a serving network node and one or more neighbor network nodes associated with multiple positioning sessions of multiple target devices;
receive the spectrum sensing information from the serving network node and the one or more neighboring network nodes;
calculate, using the received spectrum sensing information, sounding reference signal (SRS) resources to be utilized by at least one of the multiple target devices;
indicate, to the serving network node associated with at least one of the multiple positioning sessions, a list of SRS configurations obtained based on the calculated SRS resources; and
receive, from the serving network node, an indication of a selected at least one of the SRS configurations.

63. The apparatus of claim 62, wherein the request for spectrum sensing information comprises an indication of which spectrum utilization metrics are to be measured, wherein the spectrum utilization metrics comprise reference signal received power.

64. The apparatus of claim 62, wherein the request for spectrum sensing information comprises a request for a spectrum utilization report per transmission-reception point (TRP) beam.

65. The apparatus of claim 62, wherein at least one of the serving network node and neighbor network nodes comprise gNBs or TRPs.

66. The apparatus of claim 62, wherein the apparatus comprises, or is comprised in a location management function.

67. The apparatus of claim 62, wherein the request for spectrum sensing information comprises at least one of a list of carrier frequencies, component carriers, frequency range or bandwidth parts for which the network nodes should report spectrum utilization.

68. The apparatus of claim 62, wherein the calculating comprises combining the spectrum sensing information from a positioning process of interest with other concurrent positioning processes involving the same serving or neighboring network nodes.

69. The apparatus of claim 62, wherein the calculating comprises obtaining SRS configuration sets per network node, and wherein the list of SRS configurations comprises the SRS configurations in order of preference.

70. The apparatus of claim 62, wherein the calculating comprises applying a switching method to switch between SRS configuration sets as indicated from layer 1 or higher layer signaling.

71. An apparatus, comprising:
at least one processor; and
at least one memory comprising computer program code,
the at least one memory and computer program code configured, with the at least one processor, to cause the apparatus at least to:
receive a request for spectrum sensing from a location management entity;
perform the spectrum sensing; and
transmit an outcome of the spectrum sensing to the location management entity.

72. The apparatus of claim 71, wherein the request for spectrum sensing information comprises an indication of which spectrum utilization metrics are to be measured, wherein the spectrum utilization metrics comprise reference signal received power.

73. The apparatus of claim 71, wherein the request for spectrum sensing information comprises a request for a spectrum utilization report per transmission-reception point (TRP) beam.

74. The apparatus of claim 71, wherein the at least one memory and computer program code are configured, with the at least one processor, to cause the apparatus at least to:
receive, from the location management entity, a list of sounding reference signal (SRS) configurations;
evaluate the list of SRS configurations and select at least one of the SRS configurations; and
transmit, to the location management entity, an indication of the selected at least one of the SRS configurations.

75. The apparatus of claim 71, wherein, to perform the spectrum sensing, the at least one memory and computer program code are configured, with the at least one processor, to cause the apparatus at least to measure average noise level occupied over a channel bandwidth of an indicated spectrum without any uplink transmission scheduling.

76. The apparatus of claim 71, wherein, to perform the spectrum sensing, the at least one memory and computer program code are configured, with the at least one processor, to cause the apparatus at least to measure a received power and a noise power on SRS transmitted from co-scheduled user equipments.

77. The apparatus of claim 71, wherein, to perform the spectrum sensing, the at least one memory and computer program code are configured, with the at least one processor, to cause the apparatus at least to measure a received power and a noise and interference power on SRS transmitted from the co-scheduled user equipments.

78. A method, comprising:
transmitting, respectively, a request for spectrum sensing information to a serving network node and one or more neighbor network nodes associated with multiple positioning sessions of multiple target devices;
receiving the spectrum sensing information from the serving network node and the one or more neighboring network nodes;
calculating, using the received spectrum sensing information, sounding reference signal (SRS) resources to be utilized by at least one of the multiple target devices;
indicating, to the serving network node associated with at least one of the multiple positioning sessions, a list of SRS configurations obtained based on the calculated SRS resources; and
receiving, from the serving network node, an indication of a selected at least one of the SRS configurations.

79. The method of claim 78, wherein the request for spectrum sensing information comprises an indication of which spectrum utilization metrics are to be measured, wherein the spectrum utilization metrics comprise reference signal received power.

80. The method of claim 78, wherein the request for spectrum sensing information comprises a request for a spectrum utilization report per transmission-reception point (TRP) beam.

81. The method of claim 78, wherein at least one of the serving network node and neighbor network nodes comprise gNBs or TRPs.
